(19) United States
(12) Patent Application Publication
(10) Pub. No.: US 2013/0335914 A1
(43) Pub. Date: Dec. 19, 2013

(54) DOCKING STATION FOR PORTABLE TERMINAL

(71) Applicant: Samsung Electronics Co., Ltd., Gyeonggi-do (KR)

(72) Inventor: John-Gy LEE, Gyeonggi-do (KR)

(21) Appl. No.: 13/909,330

(22) Filed: Jun. 4, 2013

(30) Foreign Application Priority Data
Jun. 19, 2012 (KR) 10-2012-0065348

(51) Int. Cl. G06F 1/16

(52) U.S. Cl. CPC G06F 1/1632
USPC 361/679.41

(57) ABSTRACT

A docking station for a portable terminal includes: a body configured with a connection member to allow the portable terminal to be removably mounted to the body; and the connection member is installed to be movable on the body, the connection member comprising connection terminals, wherein when the portable terminal is mounted on the docking station, the connection member approaches the portable terminal to connect the connection terminals to the portable terminal. The connection body, in which the connection terminals are arranged, can be moved together with a portable terminal on the body of the docking station while being connected with the portable terminal using a point contact structure. Therefore, it is possible to reduce the risk of damage of the connection body due to the movement of the portable terminal Further, the connection body may approach to a portable terminal by the attractive force of one or more magnetic bodies or the like to connect the connection terminals with the portable terminal.

### CLAIM OF PRIORITY

This application claims the priority under 35 U.S.C. §119(a) from a Korean patent application entitled “Docking Station For Portable Terminal” filed in the Korean Intellectual Property Office on Jun. 19, 2012 and assigned Serial No. 10-2012-0065348, the contents of which are hereby incorporated by reference in its entirety.

### BACKGROUND

1. Field of the Invention

The present disclosure relates to a portable terminal, and more particularly to a docking station which enables a portable terminal to be variously used.

2. Description of the Related Art

In general, a portable terminal means a device that provides a function to allow a user to communicate with another user or to access a service provided by a service provider through a mobile communication base station while the user is carrying the portable terminal. Service areas through a portable terminal have rapidly expanded with the progress of mobile communication technologies and information and the communication industry. For example, although the early mobile communication services were limited to calling a counterpart, voice communication, or a short message transmission or the like, service areas have gradually expanded to a multimedia service to reproduce still/moving images, an entertainment service to produce games, and a financial service to provide mobile banking. Further, users of the mobile communication services have been gradually popularized from young people to older people.

Recently, multimedia services through a portable terminal have been strengthened, and portable terminals, such as smart phones and tablet PCs, that are functionally nearly at the level of conventional personal computers, are commercially available. Therefore, an environment is established in which an individual is capable of accessing the Internet or enjoying still/moving pictures, and even performing office work using a smart phone or a tablet PC while he or she is moving. As they are usually being equipped with a display device employing a touch screen in place of a keyboard having physical switches, portable terminals are provided in most instances with an enlarged display device.

When extending the functions of a smart phone or a tablet PC, a docking station is typically utilized as a considerably useful accessory device.

An example of the simplest docking station has a construction configured to charge a battery pack in a state in which a portable terminal is cradled. Since a portable terminal is typically provided with an interface connector, to which a charging cable can be directly connected, docking stations used only to charge a smart phone, a tablet PC, or the like, are gradually disappearing. However, as the multimedia functions of a portable terminal are strengthened, some kinds of charging cradles gradually take a form of a support to which a portable terminal may be cradled.

In addition, as a memory with a considerable capacity is incorporated in a portable terminal itself, it becomes possible to store various types of multimedia files in the portable terminal Accordingly, a docking station has appeared which allows a portable terminal to be mounted thereon and to be connected to an external audio or video device. That is, a portable terminal to reproduce a multimedia file is coupled to a docking station so that sounds and/or images of the multimedia file can be output through a speaker or a display device installed on the docking station.

A docking audio is a representative example of such a multimedia docking station. An ordinary audio device reproduces a file stored in a storage media such as a compact disk (CD). As compared with the storage media for an ordinary audio device, a user may freely store a file in a portable terminal. Therefore, upon possessing a docking station which incorporates a function of an audio device, the user may use more various and plentiful multimedia contents through the portable terminal.

Further, a docking station of another type is a docking station configured to extend or add an input device of a portable terminal, specifically a keyboard. Since a smart phone or a tablet PC has come close to a home computer or a desk top in performance, it is possible to perform business-related work or to surf the web by only using the smart phone or the tablet PC. In addition, the smart phone or the tablet PC has an advantage of excellent mobility as compared to a notebook computer or the like. Similarly, carrying an input device-extended docking station is cumbersome as compared to simply carrying a portable terminal only. However, the docking station is useful during long-range transport by public transportation means, such as a train, or the like. That is, if desired during long-range transport, the user may utilize a portable terminal, such as a tablet PC, substantially in the same manner as a notebook computer through the input device-extended docking station.

In order to utilize such a docking station, it is evident that it is necessary to provide a structure that has a stable connection with the portable terminal. A portable terminal is typically provided with an interface connector to charge or to connect to an external device. The user connects a separate cable to the interface connector of the portable terminal to charge the portable terminal or to connect the portable terminal to an external device.

A conventional docking station is provided with a connector corresponding to such an interface connector. The connector of the docking station is configured to be inserted into the interface connector of the portable terminal by a predetermined depth. Therefore, there is an advantage in that the connection between the docking station and the interface terminal of the portable terminal can be established stably. However, there is a problem in that when an external force is applied to the docking station configured as described above in the state in which the portable terminal is connected to the docking station, the connector of the docking station or the interface connector of the portable terminal may be damaged. That is, if the portable terminal is moved in a direction in the state in which the docking station is fixed, the docking station or the portable terminal may be damaged at the connector connection part.

As an alternative, a docking station has been proposed in which a point contact connector configured to be point-contacted with a portable terminal is implemented using a pogo pin. The docking station configured to be connected with a portable terminal through the point contact connector has an advantage in that the docking station involves less risk of damage even if the portable terminal is moved in relation to the docking station since the docking station is not connected with the portable terminal at the connector part. However, when the portable terminal is moved in relation to the docking station, the point contact connector may lose its connection with the portable terminal.

In addition, when the portable terminal is moved within a predetermined range in the state in which the docking station provided with the point contact connector is fixed, connection and disconnection may be alternately repeated between the portable terminal and the docking station until the portable terminal is returned to its fixedly mounted position on the docking station. In such a case, there is a danger that a software error may be caused to make the portable terminal malfunction.

Accordingly, there is a need to have a docking station wherein when the portable terminal is moved in relation to the docking station by an external force, neither the docking station or portable terminal is damaged, where a connection between the portable terminal and docking station is not lost either permanently or temporarily, and where a software error does not occur that may cause the portable terminal to malfunction.

### SUMMARY OF

Accordingly, an exemplary aspect of the present invention is to solve the above-mentioned problems occurring in the prior art, and to provide a docking station which can be prevented from being damaged even when a portable terminal is moved by an external force.

Another exemplary aspect of the present invention is to provide a docking station which can maintain a stable connection condition even when a portable terminal is moved by an external force.

In accordance with an exemplary aspect of the present invention, there is provided a docking station for a portable terminal, including: a body configured with a connection member to allow the portable terminal to be removably mounted to the body; and the connection member is installed to be movable on the body, the connection member comprising connection terminals, wherein when the portable terminal is mounted on the docking station, the connection member approaches the portable terminal to connect the connection terminals to the portable terminal.

The docking station may further include a magnetic body installed on the connection member, so that when the portable terminal is mounted, the connection member approaches to the portable terminal to be attached to an outer peripheral surface of the portable terminal by the attractive force between the magnetic body and the portable terminal.

### BRIEF DESCRIPTION OF THE DRAWINGS

The above and other exemplary aspects, features and advantages of the present invention will be more apparent from the following detailed description taken in conjunction with the accompanying drawings, in which:

FIG. 1 is a perspective view illustrating how to couple a portable terminal to a docking station according to an exemplary embodiment of the present invention;

FIG. 2 is a perspective view illustrating the portable terminal and the docking station illustrated in FIG. 1 in the state in which the portable terminal is coupled to the docking station and folded;

FIG. 3 is a side view illustrating a part of the portable terminal and the docking station illustrated in FIG. 1 in the state in which the portable terminal is coupled to the docking station and folded;

FIG. 4 is a perspective view illustrating a connection member for the docking station illustrated in FIG. 1;

FIG. 5 is a longitudinal sectional view of the connection member illustrated in FIG. 4;

FIG. 6 is a cross-sectional view illustrating the connection member of FIG. 4 installed in the docking station; and

FIG. 7 is a cross-sectional view illustrating the connection member of FIG. 4 movably coupled to the docking station.

### DETAILED DESCRIPTION

Hereinafter, exemplary embodiments of the present invention will be described in detail with reference to the accompanying drawings. For the purposes of clarity and simplicity, a detailed description of known functions and configurations incorporated herein will be omitted as it may make the subject matter of the present invention unclear.

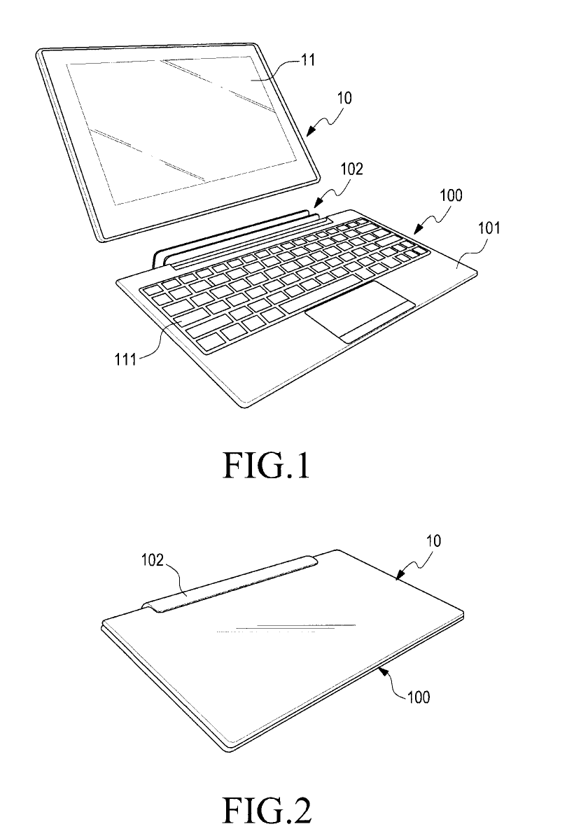

As shown in FIGS. 1 to 3, the docking station 100 according to an exemplary embodiment of the invention includes a body 101 which is provided with a keyboard 111 of a qwerty arrangement on one face of the body 101, in which the body 101 includes a docking member 102 provided adjacent to an edge of the face of the body 101. A portable terminal 10, such as a table PC, may be removably attached to the docking member 102. The portable terminal 10 is provided with a display device 11 on the front face of the portable terminal 10. Although not illustrated, some physical keys may be installed at a side of the display device 11 or on a lateral face of the portable terminal 10. In the state in which the portable terminal 10 is mounted on the docking station 100, a user may use the keyboard 111 as an input device. That is, it is possible to extend the input device of the portable terminal 10 by mounting the portable terminal 10 in the docking member 102 of the docking station 100.

Although the present exemplary embodiment exemplifies a construction in which the docking member 102 is mounted to be pivotable on the body 101, a certain product may not employ such a separate docking member 102 shown in FIGS. 1-3, or a certain product may be configured to have a docking member fixed to the body thereof. That is, a docking recess may be formed on the body of the docking station 100 such that a portable terminal can be removably attached to the docking recess. In addition, although the present exemplary embodiment exemplifies the docking member 102 which is configured to wrap a side edge of the portable terminal 10, it is possible to form a docking recess configured to wrap the side edge and the rear face on the body 101 without providing a docking member 102 as described above.

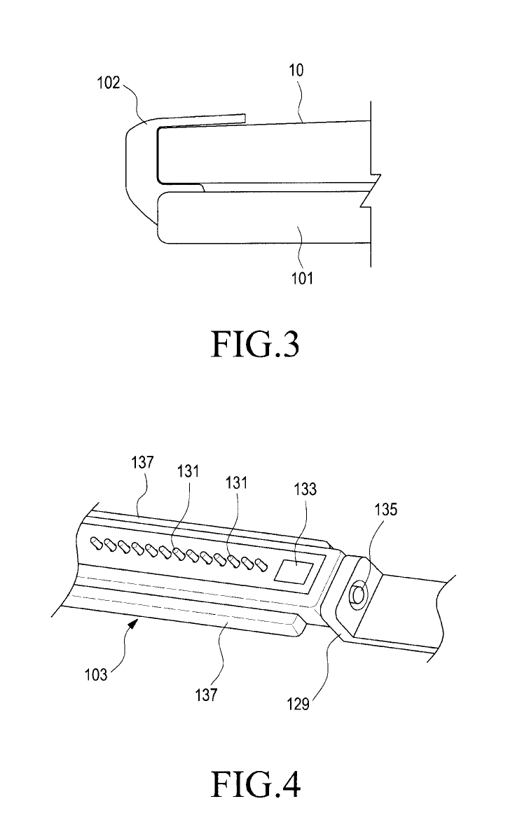

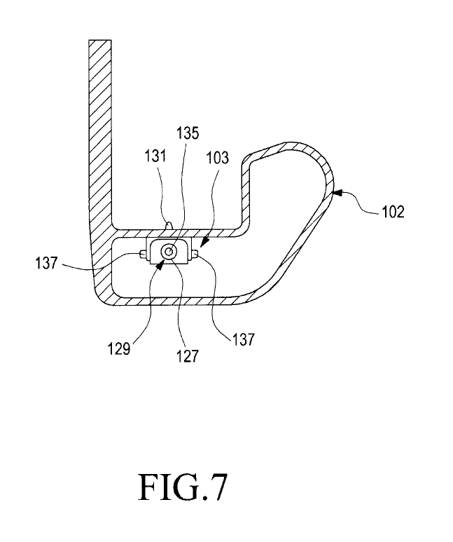

The docking member 102 is pivotably mounted at an edge of one face of the body 101. In order to couple the docking member 102 to the body 101 to be rotatable, the docking station 100 is provided with hinge lugs 135 that are connected to a connection member 103 mounted on the body 101 (see FIG. 7). Accordingly, as the docking member 102 pivots on the body 101, the portable terminal 10 mounted on the docking member 102 is capable of being folded to come into contact with the face of the body 101, more specifically the keyboard 111 as illustrated in FIG. 3. In addition, as desired, the user may rotate the portable terminal 10 mounted on the docking member 102 in relation to the body 101 to fold the portable terminal 10 as illustrated in FIG. 2. Therefore, the user may carry only the portable terminal 10, such as a tablet PC, or may couple the portable terminal 10 to the docking station 100 to carry or use the portable terminal 10 like a standard notebook computer. As a result, the docking station 100 may be used as cradle which is relatively convenient to carry and simple while extending the input device of the portable terminal 10.

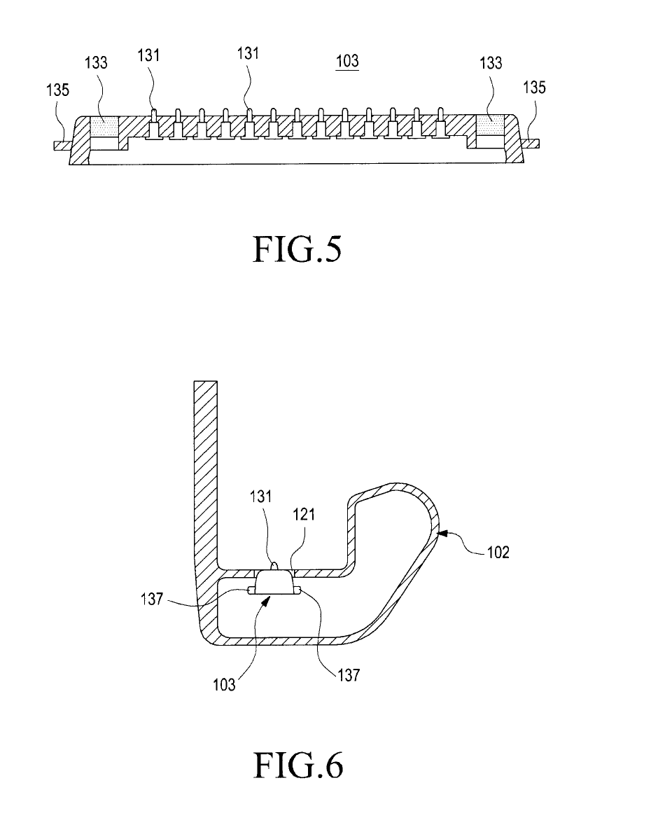

Referring to FIGS. 4 and 5, the docking station 100 includes a connection member 103 for electric connection with the portable terminal 10. The connection member 103 includes connection terminals 131 corresponding to the connector terminals provided on the portable terminal 10. Although the connection terminals 131 are illustrated as being arranged in a row on one face of the connection member 103, the connection terminals 131 may be arranged in two or three rows. The arrangement should be properly set depending on the specification of the portable terminal 10 mounted on the docking station 100.

The connection member 103 is mounted on the body 101 of the docking station 100, or more specifically, on the docking member 102 to be capable of being moved. Herein, the description that the connection member 103 is “moved” on the body 101 means that the connection terminal 131 is mounted on the body 101 to be movable up and down, and left and right as well as to be rotatable. In addition, although it is exemplified that the body 101 includes the docking member 102 pivotably coupled to one face thereof so that the portable terminal 10 can be removably attached to the docking member 102, it is possible to provide the docking member 102 to be fixed to the body 101, or to form a docking recess, to which the portable terminal 10 can be removably attached on the body 101 without providing a separate docking member. Therefore, although the exemplary embodiment exemplifies that the connection member 103 is installed on the docking member 102, the connection member 103 may be directly installed on the body 101.

Referring to FIG. 7, hinge lugs 135 extend from the opposite ends of the connection member 103, respectively. The hinge lugs 135 are coupled to the inside of the docking member 102 to be capable of being rotated while being moved up and down, and left and right. In order to couple the connection member 103 to the inside of the docking member 102, the docking station 100 may be provided with support members 129. The support members 129 are mounted adjacent to the opposite ends of the connection member 103, respectively, within the inside of the body 101, and more specifically within the inside of the docking member 102 such that each of the support members 129 wrap one of the hinge lugs 135. That is, the hinge lugs 135 are rotatably coupled to the inside of the docking member 102 in the state in which the hinge lugs 135 are wrapped by the support members 129, respectively.

Each of the support members 129 are formed with a hinge hole 127 for receiving one of the hinge lugs 135 as illustrated in FIG. 7. The diameter of the hinge holes 127 is larger than the cross-sectional diameter of the hinge lugs 135. The hinge lugs 135 are configured to be capable of being rotated within the hinge holes 127 as well as being moved up and down, left and right within a predetermined range. Consequently, since the hinge lugs 135 can be moved within the hinge holes 127, the connection member 103 is moved in order to move the connection terminals 131 up and down, and left and right.

Referring to FIGS. 6 and 7, the opposite lateral sides of the connection member 103 are formed with stoppers 137, respectively. As described below, the stoppers 137 prevent the inside of the docking member 102 from being exposed through an opening 121 (see FIG. 6) formed through one face of the docking member 102. For example, the face that wraps the edges of the portable terminal 10 when the portable terminal 10 is coupled to the docking member 102, and the stoppers 137 limit the rotation range of the connection member 103. Referring to FIG. 6 again, the opening 121 is formed in the docking member 102 to partially expose the connection member 103. When the connection member 103 is mounted within the docking member 102 through the support members 129, one face of the connection member 103, more specifically the connection terminals 131, are exposed to the outside of the docking member 102 through the opening 121. In such a case, the stoppers 137 protrude from the opposite lateral sides of the connection member 103, respectively, to shield the gaps between the inner walls of the opening 121 and the lateral sides of the connection member 103. As a result, the stoppers 137 block the exposure of the inside of the docking member 102 through the opening 121. In addition, when the connection member 103 is rotated about the hinge lugs 135, the stoppers 137 interfere with the inner peripheral surface of the docking member 102 to limit the rotation range of the connection member 103.

Consequently, the connection member 103, more specifically the connection terminals 131 can be moved up and down, and left and right on the docking member 102 as well as rotated within a predetermined angular range.

Referring to FIGS. 4 and 5, the connection member 103 is installed to be capable of being moved on the docking member 102, when the portable terminal 10 is mounted on the docking member 102, the connection member 103 approaches the portable terminal 10 to have the connection members 131 connected to the portable terminal 10. This can be realized by either installing an elastic body compressing the connection member 103 within the inside of the docking member 102, or by using an magnetic body 133 to produce an attractive force between the connection member 103 and the portable terminal 10. The present exemplary embodiment exemplifies that the docking station 100 is provided with magnetic bodies 133 which are installed on the connection member 103.

It is possible to provide only one magnetic body 133. However, since the connection terminals 131 are arranged in one row, it is preferable that a pair of magnetic bodies 133 are located adjacent to the opposite ends of the connection member 103, respectively, and that the connection terminals 131 are arranged between the magnetic bodies 133. In such an embodiment, the portable terminal 10 removably attached to the docking station 100 may be preferably provided with metal members or magnetic bodies 133 corresponding to the magnetic forces of the magnetic bodies 133.

If the docking station 100 is fabricated only for a specific product, it is possible to fabricate the product, i.e. a corresponding terminal, which is previously provided with metallic members or magnetic bodies. In such an embodiment, the connection member 103 may be attached and coupled to the portable terminal 10 by the attractive force between the metallic members or the metallic bodies installed in the portable terminal and the magnetic bodies 133. However, if factors, for example, the sizes of portable terminals and the positions of connector terminals of the portable terminals are standardized, and the docking station 100 can be universally used for the standardized portable terminals, the user may attach the metallic members or the magnetic bodies 133 to the portable terminals as desired. Of course, if the housing or the like of the portable terminal 10 is formed of a magnetizable material, it may be needless to provide the separate metal members or the magnetic bodies 133 in the standardized portable terminals.

Referring again to FIGS. 4 and 5, by installing the magnetic bodies 133 on the connection member 103 to produce attractive force between the connection member 103 and the portable terminal 10 mounted on the docking member 102, the connection terminals 131 can be stably connected with the connector terminals of the portable terminal 10. That is, when the portable terminal 10 is mounted on the docking member 102, the connection member 103 will be attached to the portable terminal 10 by the attractive force of the magnetic bodies 133, and the connection terminals 131 will be connected with the connector terminals of the portable terminal 10. That is, even if the connection member 103 is installed to be capable of being moved on the docking member 102, the connection member 103 will be stably coupled to the portable terminal 10 by the attractive force of the magnetic bodies 133 when the portable terminal 10 is mounted on the docking member 102.

Meanwhile, the connection terminals 131 may be constituted by pogo pins. When the connection member 103 is attached and coupled to the portable terminal 10 by the attractive force of the magnetic bodies 133, the connection terminals 131 constituted by the pogo pins are point-contacted with the connector terminals of the portable terminal 10. In such a case, even if the portable terminal 10 is moved within a predetermined range in the state in which it is mounted on the body 101, or more specifically on the docking member 102, since the connection member 103 is movable on the docking member 102, the connection member 103 may be maintained in the state in which the connection member 103 is attached to the portable terminal 10. This is because the connection member 103 tends to approach the portable terminal 10 by the attractive force of the magnetic bodies 133 in the state in which the portable terminal 10 is mounted on the docking station 100. Therefore, even if the portable terminal 10 is moved in the state in which it is mounted on the docking station 100, the connection terminals 131 can remain stably connected with the connector terminals of the portable terminal 10.

As described above, the inventive docking station can establish a stable electrical connection with a portable terminal since the docking station enables a connection member, in which connection terminals are arranged, to be attached and coupled to the portable terminal by magnetic bodies. In addition, since the connection member is configured to be capable of being moved within a predetermined range on the docking station, it is possible to prevent the connection between the portable terminal and the docking station from being disconnected even if the connection member is moved in the state in which the portable terminal is mounted on the docking station.

Although the present invention has been described in detail with reference to certain exemplary embodiments, it will be obvious to those skilled in the art that various modifications may be made without departing from the spirit and scope of the invention. For example, although it has been exemplified that a separate pivotable docking member is installed on the docking station, it is possible to form a docking recess for receiving a portable terminal on the body of the station as described above. In such an embodiment, the connection member should be installed to be movable on the body of the docking station.

Furthermore, although it has been exemplified that the docking station is provided with a keyboard, it is obvious that the inventive connection member may be provided in a docking station, which is configured to provide a function for connecting a portable terminal with another device, for example a docking stand, on which a portable terminal may be cradled when it is desired to connect the portable terminal with an external device, or for example, a personal computer, a charging device, a video device, such as a television set or a beam projector, an audio device, such as a docking audio, of which a speaker device is mounted on the body of a docking station, or the like.

The docking station as described above is configured such that the connection body, in which the connection terminals are arranged, can be moved together with a portable terminal on the body of the docking station while being connected with the portable terminal using a point contact structure. Therefore, it is possible to reduce the risk of damage of the connection body due to the movement of the portable terminal In addition, since the connection body may approach a portable terminal, for example by the attractive force of magnetic bodies or the like such that the connection terminals can be connected with the portable terminal, a stable connection condition can be maintained.

What is claimed is:

1. A docking station for a portable terminal, comprising:
a body configured with a connection member to allow the portable terminal to be removably mounted to the body; and
the connection member installed on the body and comprising connection terminals,
wherein when the portable terminal is mounted on the docking station, the connection terminals of the connection member approach the portable terminal to connect to the portable terminal.

2. The docking station as in claim 1, further comprising:
a magnetic body installed on the connection member,
wherein when the portable terminal is mounted, the connection member approaches the portable terminal to be attached to an outer peripheral surface of the portable terminal by an attractive force between the magnetic body and the portable terminal.

3. The docking station as in claim 1, wherein a pair of magnetic bodies are arranged on the connection member, and the connection terminals are arranged between the magnetic bodies.

4. The docking station as in claim 1, further comprising:
a plurality of hinge lugs extending from a plurality of opposite ends of the connection member, respectively; and
a plurality support members mounted within an inside portion of the body, and coupled to wrap the plurality of hinge lugs,
wherein the plurality of hinge lugs is rotatably coupled to the plurality of support members, respectively.

5. The docking station as in claim 4, further comprising:
a plurality of hinge holes are formed in the plurality of support members to receive the plurality of hinge lugs, respectively,
wherein a diameter of each of the plurality of hinge holes is larger than a cross-sectional diameter of each of the plurality hinge lugs such that the plurality of hinge lugs is movable in the plurality of hinge holes.

6. The docking station as in claim 1, the body comprising:
a docking member installed to be pivotable at a side edge of the body, and the portable terminal removably attached to the docking member.

7. The docking station as in claim 6, wherein the portable terminal is coupled to the docking member to pivot together with the docking member on the body to allow the portable terminal to be folded to come into contact with one face of the body or to be unfolded from the body.

8. The docking station as in claim 7, further comprising:
a keyboard of a qwerty arrangement provided on the one face of the body,
wherein when the portable terminal is folded to the body, the keyboard comes into contact with the portable terminal.

9. The docking station as in claim 6, wherein the docking member is coupled to wrap a side edge of the portable terminal.

10. The docking station as in claim 6, wherein the connection member is installed on the docking member to be movable.

11. The docking station as in claim 10, further comprising:
an opening formed on one face of the docking member,
wherein when the connection member is installed within an inside portion of the docking member, the connection terminals protrude to an outside portion of the docking member through the opening.

12. The docking station as in claim 11, further comprising:
a plurality of hinge lugs extending from a plurality of opposite ends of the connection member, respectively; and
a plurality of support members mounted within the inside portion of the body, each of the plurality of support members being coupled to wrap one of the plurality of hinge lugs,
wherein the plurality of hinge lugs are wrapped by and rotatably coupled to the plurality of support members, respectively.

13. The docking station as in claim 12, further comprising:
a plurality of hinge holes formed in the plurality of support members to receive the plurality of hinge lugs, respectively,
wherein a diameter of each the plurality of hinge holes is larger than a cross-sectional diameter of each of the plurality of hinge lugs such that the plurality of hinge lugs are movable in the plurality of hinge holes.

14. The docking station as in claim 6, further comprising:
a pair of magnetic bodies installed on the connection member,
wherein when the portable terminal is mounted, the connection member approaches the portable terminal to be attached to an outer peripheral surface of the portable terminal by an attractive force between the pair of magnetic bodies and the portable terminal.

15. The docking station as in claim 1, wherein the connection terminals are pogo pins.

16. The docking station as in claim 1, further comprising:
a plurality of hinge lugs provided to the connection member,
wherein the plurality of hinge lugs is rotatably coupled within an inside portion of the body, respectively to allow the connection member to rotate in relation to the body.

17. The docking station as in claim 16, wherein the connection member is configured to move in a horizontal and vertical direction in the body.

18. The docking station as in claim 16, wherein the plurality of hinge lugs are configured on an inside portion of the docking member to allow the plurality of hinge lugs to rotate while moving in a horizontal or vertical direction.

19. The docking station as in claim 16, further comprising:
a pair of magnetic bodies to produce an attractive force between the connection member and the portable terminal.

20. The docking station as in claim 1, wherein the connection terminals are configured with pogo pins to allow the portable terminal to remain in connect with the connection member when the portable terminal is moved within a predetermined range.

21. A docking station for a portable terminal, comprising:
a body configured to allow the portable terminal to be removably mounted to the body;
a connection member installed on the body and comprising connection terminals;
hinge lugs extending from both ends of the connection member, respectively;
support members mounted within an inside portion of the body; and
hinge holes are formed in the support members to receive the hinge lugs, respectively,
wherein a diameter of each of the hinge holes is larger than a cross-sectional diameter of each of the hinge lugs such that the hinge lugs is movable in the hinge holes, respectively and when the portable terminal is mounted on the docking station, the connection member approach the portable terminal to connect the connection terminals to the portable terminal.

22. The docking station as in claim 21, wherein the hinge lugs is rotatably coupled in the hinge holes, respectively.

23. The docking station as in claim 21, further comprising:
at least one magnetic body installed on the connection member,
wherein when the portable terminal is mounted, the connection member approaches the portable terminal to be attached to an outer peripheral surface of the portable terminal by an attractive force between the magnetic body and the portable terminal.

24. The docking station as in claim 23, wherein a pair of the magnetic bodies are arranged on the connection member, and the connection terminals are arranged between the magnetic bodies.
